(19) United States
(12) Patent Application Publication
(10) Pub. No.: US 2023/0094159 A1
(43) Pub. Date: Mar. 30, 2023

(54) SYSTEM AND METHOD FOR DYNAMICALLY PARTITIONED MULTI-TENANT NAMESPACES

(71) Applicant: Oracle International Corporation, Redwood Shores, CA (US)

(72) Inventors: David DIFRANCO, St. Louis, MO (US); David CRAFT, Portland, OR (US); Daniel FEIST, Wokingham (GB); Michal CHMIELEWSKI, San Jose, CA (US)

(21) Appl. No.: 17/487,964

(22) Filed: Sep. 28, 2021

(51) Int. Cl. G06F 9/50; G06F 9/455

(52) U.S. Cl. CPC G06F 9/5072; G06F 9/5077; G06F 9/45558; G06F 2009/4557; G06F 2009/45595; G06F 2209/505

(57) ABSTRACT

Systems and methods for supporting dynamically partitioned multi-tenant namespaces. A method can provide a computer including one or more microprocessors, a cloud infrastructure environment, and a containerized application provider within the cloud infrastructure environment. The method can define a plurality of partitions by the containerized application provider. The method can populate, by the containerized application provider, one or more pods of a plurality of pods within each of the plurality of partitions. The method can assign each of plurality of partitions a uniquely addressable namespace. The method can assign, respectively, each of a plurality of tenants, to a partition of the plurality of partitions.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

Embodiments of the invention are generally related to cloud services, such as integration cloud services, and in particular, systems and methods for supporting dynamically partitioned multi-tenant namespaces.

### BACKGROUND

Integration cloud services (ICS) (e.g., Oracle Integration Cloud Service) are simple and powerful integration platforms in the cloud that assist in the utilization of products, such as Software as a Service (SaaS) and on-premises applications. ICS can be provided as an integration platform as a service (iPaas) and can include a web-based integration designer for point and click integration between applications, a rich monitoring dashboard that provides real-time insight into the transactions.

ICS and other services can be run within a multitenant cloud environment where resources are finite. Often times such services run into issues with resource starvation, such as CPU and compute resource starvation when one tenant runs away with a process or processes that utilize a majority of the finite number of resources provided to such services. In such cases, other tenants of the multitenant cloud environment may be starved of resources and unable to utilize ICS or other services.

### SUMMARY

In accordance with an embodiment, systems and methods for supporting dynamically partitioned multi-tenant namespaces are provided. A method can provide a computer including one or more microprocessors, a cloud infrastructure environment, and a containerized application provider within the cloud infrastructure environment. The method can define a plurality of partitions by the containerized application provider. The method can populate, by the containerized application provider, one or more pods of a plurality of pods within each of the plurality of partitions. The method can assign each of plurality of partitions a uniquely addressable namespace. The method can assign, respectively, each of a plurality of tenants, to a partition of the plurality of partitions.

In accordance with an embodiment, the systems and methods described herein can provide support for limited isolation in runtime by ensuring that a subset of service instances is accessing a particular runtime container at a time

In accordance with an embodiment, the systems and methods described herein can support density by not permanently dedicating runtime containers to any customer/user/tenant.

In accordance with an embodiment, the systems and methods described herein can provide resource affinity. That is, put another way, the systems and methods support resource affinity in terms of having a same instance of an integration application adapters accessing the same external application. This provides for improved in-memory cache affinity, e.g. for integration definitions. As well, this also limits connection fan-out to a relational database (e.g., relational database management system or “RDBMS”, an example of which is ATP—autonomous transaction processing) adapters.

### BRIEF DESCRIPTION OF THE DRAWINGS

FIG. 1 shows a system for providing a cloud infrastructure environment, in accordance with an embodiment.

FIG. 2 illustrates an ICS platform for designing and executing an ICS integration flow, in according with an embodiment.

FIG. 3 illustrates an integration cloud service in accordance with an embodiment.

FIG. 4 shows a system for supporting dynamically partition multi-tenant namespaces, in accordance with an embodiment.

FIG. 5 shows a system for supporting dynamically partition multi-tenant namespaces, in accordance with an embodiment.

FIG. 6 shows a system for supporting dynamically partition multi-tenant namespaces, in accordance with an embodiment.

FIG. 7 shows a system for supporting dynamically partition multi-tenant namespaces, in accordance with an embodiment.

FIG. 8 shows a system for supporting dynamically partition multi-tenant namespaces, in accordance with an embodiment.

FIG. 9 is a flowchart of a method for supporting dynamically partitioned multi-tenant namespaces, in accordance with an embodiment.

### DETAILED DESCRIPTION

The foregoing, together with other features, will become apparent upon referring to the enclosed specification, claims, and drawings. Specific details are set forth in order to provide an understanding of various embodiments. However, it will be apparent that various embodiments may be practiced without these specific details. The enclosed specification and drawings are not intended to be restrictive.

Integration platform as a Service, for example, Oracle Integration Cloud Service (ICS), can provide a cloud-based platform for building and deploying integrations flows that connect applications residing in the cloud or on-premises. Such integration platforms can be run within, e.g., a cloud infrastructure environment.

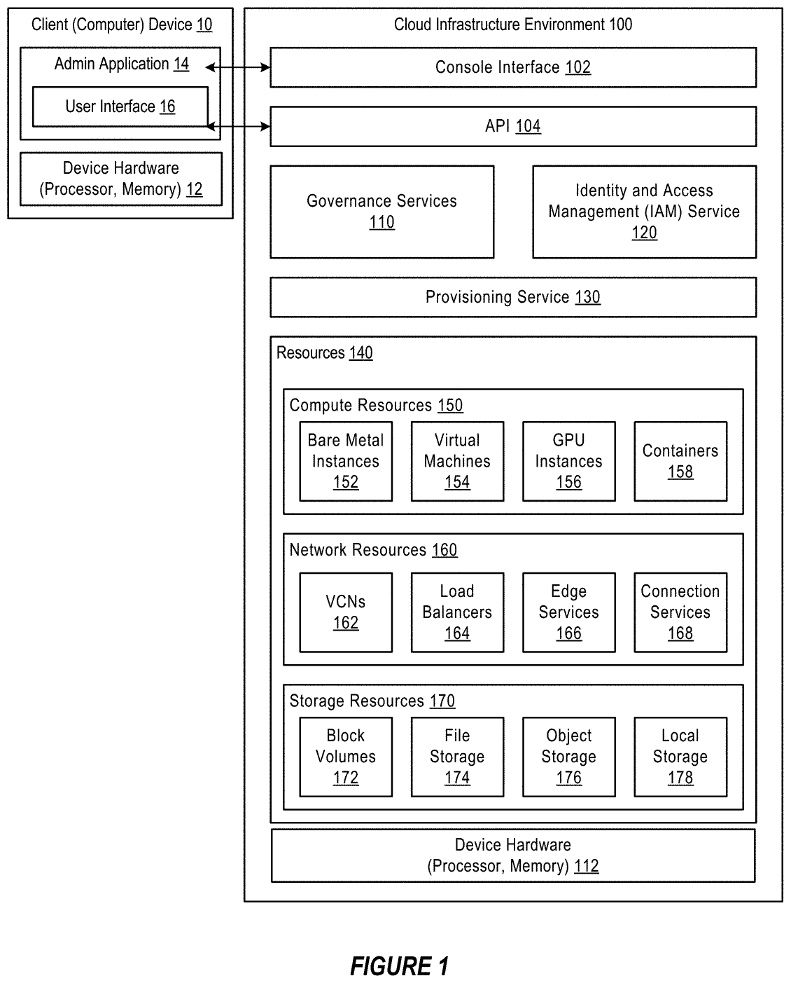

FIG. 1 shows a system for providing a cloud infrastructure environment, in accordance with an embodiment.

In accordance with an embodiment, a cloud infrastructure environment 100, which can be run on a number of hardware and software resources 112, can comprise a console interface 102 and an API 104. In addition, the cloud infrastructure environment 100 can support a number of governance services 110, an identity and access management (IAM) service 120, and a provisioning service 130. The cloud infrastructure environment 100 can also support a number of resources 140, e.g., in layers, such as a computer resource layer 150, a network resource layer 160, and a storage resource layer 170.

In accordance with an embodiment, a client device, such as a computing device 10 having device hardware (processor, memory . . . etc.) 12, can communicate with the cloud infrastructure environment via a network, such as a wide area network (WAN), a local area network (LAN), or the internet, for example. The client device can comprise an administrator application 14, which can comprise a user interface 16.

In accordance with an embodiment, within the cloud infrastructure environment, tenancy can be supported. On registration and deployment, a tenancy can be created for each client/customer, which can comprise a secure and isolated partition within the cloud infrastructure in which the client can create, organize, and administer their cloud resources.

In accordance with an embodiment, the console interface 102 and the API 104 can provide clients with access to, and control over respective portions of the could infrastructure environment. In accordance with an embodiment, the console interface can comprise an intuitive, graphical interface that lets clients create and manage resources, instances, cloud networks, and storage volumes, as well as manage users associated with the client, and set permissions within the client scope. As well, the API 104 can compromise, for example, a REST API that utilizes HTTPS (hypertext transfer protocol secure).

In accordance with an embodiment, one example of a console interface or API can be a configuration management tool (e.g., Ansible). The configuration management tool can be used for cloud infrastructure provisioning, orchestration, and configuration management. Configuration management tools can allow clients to automate configuring and provisioning of the cloud infrastructure, deploying and updating software assets, and orchestrating complex operational processes.

In accordance with an embodiment, the governance services 110 of the cloud infrastructure environment provides clients tools to help clients enable simple resource governance, manage costs, and control access to the cloud infrastructure. As an example, the governance services provide for tagging which can allow for clients to apply tags to their resources for informational or operational reasons. Defined tags can be controlled to avoid incorrect tags from being applied to resources. Tags can also provide a flexible targeting mechanism for administrative scripts. As well, the governance services can allow for managed budgets, and track actual and forecasted spend all from one place. This allows clients to stay on top of usage with a cost analysis dashboard, and filter by compartments and tags to analyze spending by departments, teams, and projects. Such data can as well be exported for detailed resource utilization reporting and integration with an existing cloud management and business intelligence tools. The governance services can also log events that can later be retrieved, stored, and analyzed for security, compliance, and resource optimization across the loud infrastructure entitlements and compartments.

In accordance with an embodiment, the identity and access management (IAM) service 120 can create a user profile for each client/customer/user in the IAM service with associated with user credential (e.g., username and password). Clients can be granted administrator privileges in the cloud infrastructure as well via the IAM service.

In accordance with an embodiment, the identity and access management service can be integrated with the cloud infrastructure environment. Upon a client registering. The IAM service can create a separate user credential in an identity service, which can then allow for single sign on to the cloud infrastructure service as well as access to additional cloud services.

In accordance with an embodiment, the provisioning service 130 can provision, for example, a tenancy within cloud infrastructure service, such as within the resources 140. The provisioning service can be accessed and controller through, for example, the console interface or via one or more APIs, such as API 104. The provisioning service can allow for lets clients to provision and manage compute hosts, which can be referred to as instances. Clients can launch instances as needed to meet compute and application requirements. After a client launches an instance, the provisioned instance can be accessed from, for example, a client device. The provisioning service can also provide for restarting an instance, attaching and detaching volumes from an instance, and terminating an instance.

In accordance with an embodiment, resources 140 provided by a cloud infrastructure environment can be broken down into a plurality of layers, such as a compute resources layer 150, a network resources layer 160, and a storage resource layer 170.

In accordance with an embodiment, the compute resources layer 150 can comprise a number of resources, such as, for example, bare metal instances 152, virtual machines 154, edge services 156, and containers 158. The compute resources layer can be used to, for example, provision and manage bare metal compute instances, provision instances as needed to deploy and run applications, just as in an on-premises data center.

In accordance with an embodiment, the cloud infrastructure environment can provide control of one or more physical host (“bare metal”) machines within the compute resources layer. Bare metal compute instances run directly on bare metal servers without a hypervisor. When ca bare metal compute instance is provisioned, the client can maintain sole control of the physical CPU, memory, and network interface card (NIC). The bare metal compute instance can be configured and utilize the full capabilities of each physical machine as if it were hardware running in an on-premise own data center. As such, bare metal compute instances are generally not shared between tenants.

In accordance with an embodiment, bare metal compute instances can provide, via the associated physical hardware as opposed to a software-based virtual environment, a high level of security and performance.

In accordance with an embodiment, the cloud infrastructure environment can provide control of a number of virtual machines within the compute resources layer. A virtual machine compute host can be launched, for example, from an image that can determine the virtual machines operation system as well as other software. The types and quantities of resources available to a virtual machine instance can be determined, for example, based upon the image that the virtual machine was launched from.

In accordance with an embodiment, a virtual machine (VM) compute instance can comprise an independent computing environment that runs on top of physical bare metal hardware. The virtualization makes it possible to run multiple VMs that are isolated from each other. VMs can be used, for example, for running applications that do not require the performance and resources (CPU, memory, network bandwidth, storage) of an entire physical machine.

In some embodiments, virtual machine instances can run on the same hardware as a bare metal instance, which can provide leverage over using the same cloud-optimized hardware, firmware, software stack, and networking infrastructure

In accordance with an embodiment, the cloud infrastructure environment can provide a number of graphical processing unit (GPU) compute instances within the compute resources layer. Accelerated computing requires consistently-fast infrastructure across every service. With GPU instances, clients can process and analyze massive data sets more efficiently, making them useful for complex machine learning (ML), artificial intelligence (AI) algorithms, and many industrial HPC applications. GPU compute instances can be provisioned as either virtualized compute instances (where multiple GPU compute instances share the same bare metal hardware), or as bare metal instances which provide dedicate hardware for each GPU compute instance.

In accordance with an embodiment, the cloud infrastructure environment can provide a number of containerized compute instances within the compute resources layer. A standalone container engine service can be used to build and launch containerized applications to the cloud. The container service can be used, for example, to build, deploy, and manage cloud-native applications. The container service can specify the compute resources that the containerized applications require, and the container engine can then provision, via the provisioning service, the required compute resources for use within the cloud infrastructure environment (e.g., in the context of a tenancy).

In accordance with an embodiment, one such container service engine that can be used is Kubernetes, an open-source system for automating deployment, scaling, and management of containerized applications across clusters of hosts. Such container services can group the containers that make up an application into logical units for easy management and discovery.

In accordance with an embodiment, the network resources layer 160 can comprise a number of resources, such as, for example, virtual cloud networks (VCNs) 162, load balancers 164, edge services 166, and connection services 168.

In accordance with an embodiment, the cloud infrastructure environment can provide a number of virtual cloud networks 162 at the networking resources layer. A virtual cloud network can comprise a virtual version of a traditional network—including subnets, route tables, and gateways—on which client instances can run. A cloud network resides within a single region but includes all the region's availability domains. Each subnet defined in the cloud network can either be in a single availability domain or span all the availability domains in the region (recommended). At least one cloud network can be configured before launching instances. In certain embodiments, VCNs can be configured via an internet gateway to handle public traffic, a VPN connection, or a fast connect service to securely extend on-premises network.

In accordance with an embodiment, the cloud infrastructure environment can provide a number of load balancers 164 at the networking resources layer. A load balancing service can provide automated traffic distribution from one entry point to multiple servers reachable from a virtual cloud network (VCN). Various load balances can provide a public or private IP address, and provisioned bandwidth.

In accordance with an embodiment, a load balancer can improve resource utilization, scaling, and help ensure high availability. Multipole load balancing policies can be configured, and application-specific health checks can be provided to ensure that the load balancer directs traffic only to healthy instances. The load balancer can reduce maintenance window by draining traffic from an unhealthy application server before it is removed from service for maintenance.

In accordance with an embodiment, a load balancing service enables creation of a public or private load balancer in conjunction with a VCN. A public load balancer has a public IP address that is accessible from the internet. A private load balancer has an IP address from the hosting subnet, which is visible only within the VCN. Multiple listeners can be configured for an IP address to load balance transport different layers of traffic (e.g., Layer 4 and Layer 7 (TCP and HTTP) traffic). Both public and private load balancers can route data traffic to any backend server that is reachable from the VCN.

In accordance with an embodiment, a public load balancer can accept traffic from the internet, a public load balance can be created that is assigned a public address, which serves as the entry point for incoming traffic.

In accordance with an embodiment, a public load balancer is regional in scope. If a region includes multiple availability domains, a public load balancer can have, for example, a regional subnet, or two availability domain-specific (AD-specific) subnets, each in a separate availability domain. With a regional subnet, the load balancer can create a primary load balancer and a standby load balancer, each in a different availability domain, to ensure accessibility even during an availability domain outage. If a load balance is created in multiple AD-specific subnets, one subnet can host the primary load balancer and the other hosts a standby load balancer. If the primary load balancer fails, the public IP address can switch to the secondary load balancer. The service treats the two load balancers as equivalent.

In accordance with an embodiment, if a region includes only one availability domain, the service requires just one subnet, either regional or AD-specific, to host both the primary and standby load balancers. The primary and standby load balancers can each have a private IP address from the host subnet, in addition to the assigned floating public IP address. If there is an availability domain outage, the load balancer has no failover.

In accordance with an embodiment, private load balances can also be provided so as to isolate the load balancer from the internet and simplify security posture. The load balancer service can assign a private address to the load balancer that serves as the entry point for incoming traffic.

In accordance with an embodiment, a private load balancer can be created by a service to service only one subnet to host both the primary and standby load balancers. The load balancer can be regional or AD-specific, depending on the scope of the host subnet. The load balancer is accessible only from within the VCN that contains the host subnet, or as further restricted by security rules.

In accordance with an embodiment, the assigned floating private IP address is local to the host subnet. The primary and standby load balancers each require an extra private IP address from the host subnet.

In accordance with an embodiment, if there is an availability domain outage, a private load balancer created in a regional subnet within a multi-AD region provides failover capability. A private load balancer created in an AD-specific subnet, or in a regional subnet within a single availability domain region, has no failover capability in response to an availability domain outage.

In accordance with an embodiment, the cloud infrastructure environment can provide a number of edge services 166 at the networking resources layer. In general, edge services comprise a number of services that allow clients to manage, secure, and maintain domains and endpoints. These include, for example, DNS (domain name system), DDoS (distributed denial of service) protection, and email delivery. These services enable clients to optimize performance, thwart cyberattacks, and scale communication.

In accordance with an embodiment, the cloud infrastructure environment can provide a number of connection services 168 at the networking resources layer. Such connection services can provide an easy way to create a dedicated, private connection between a client data center or existing network and the cloud infrastructure environment. The connection service can provide high bandwidth, and a reliable and consistent network.

In accordance with an embodiment, the storage resources layer 170 can comprise a number of resources, such as, for example, block volumes 172, file storage 174, object storage 176, and local storage 178.

In accordance with an embodiment, block volumes 172 provide high-performance network storage capacity that supports a broad range of I/O intensive workloads. Clients can use block volumes to expand the storage capacity of compute instances, to provide durable and persistent data storage that can be migrated across compute instances, and to host large databases.

In accordance with an embodiment, file storage 174 allows clients to create a scalable, distributed, enterprise-grade network file system. File storage supports semantics, snapshots capabilities, and data at-rest encryption.

In accordance with an embodiment, object storage provides high throughput storage for unstructured data. Object storage service enables near limitless storage capacity for large amounts of analytic data, or rich content like images and videos. Block volumes can be backed up to object storage for added durability.

In accordance with an embodiment, local storage 178 can provide, for example, high speed and reliable storage in the form of solid state drives for I/O intensive applications. These can be provided, for example, within bare metal instances. Local storage provides high storage performance for VM's and bare metal compute instances. Some examples include relational databases, data warehousing, big data, analytics, AI and HPC application.

### Integration Cloud Service

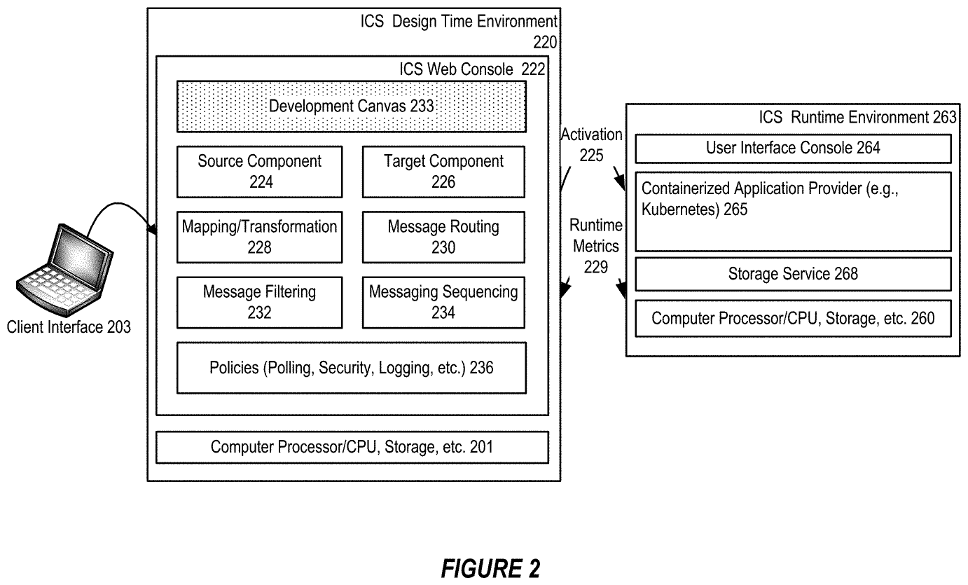

FIG. 2 illustrates an ICS platform for designing and executing an ICS integration flow, in accordance with an embodiment.

As shown in FIG. 2, the ICS platform can include a design-time environment 220, and a runtime environment 263. Each environment can execute on a computer including one or more processors, for example a computer 201 or 206.

In accordance with an embodiment, the design-time environment includes an ICS web console 222, which provides a browser-based designer to allow an integration flow developer to build integrations using a client interface 203.

In accordance with an embodiment, the ICS design-time environment can be pre-loaded with connections to various SaaS applications or other applications, and can include a source component 224, and a target component 226. The source component can provide definitions and configurations for one or more source applications/objects; and the target component can provide definitions and configurations for one or more target applications/objects. The definitions and configurations can be used to identify application types, endpoints, integration objects and other details of an application/object.

As further shown in FIG. 2, the design-time environment can include a mapping/transformation component 228 for mapping content of an incoming message to an outgoing message, and a message routing component 230 for controlling which messages are routed to which targets based on content or header information of the messages. Additionally, the design-time environment can include a message filtering component 232, for controlling which messages are to be routed based on message content or header information of the messages; and a message sequencing component 234, for rearranging a stream of related but out-of-sequence messages back into a user-specified order.

In accordance with an embodiment, each of the above of the described components, as with the source and target components, can include design-time settings that can be persisted as part of a flow definition/configuration.

In accordance with an embodiment, a flow definition specifies the details of an ICS integration flow; and encompasses both the static constructs of the integration flow (for example, message routers), and the configurable aspects (for example, routing rules). A fully configured flow definition and other required artifacts (for example, jca and .wsdl files) in combination can be referred to as an ICS project. An ICS project can fully define an integration flow, and can be implemented by an underlying implementation layer.

In accordance with an embodiment, a policies component 236 can include a plurality of policies that govern behaviors of the ICS environment. For example, a polling policy can be configured for source-pull messaging interactions (i.e., query style integrations) for a source application, to invoke an outbound call to the source application via a time-based polling.

In accordance with an embodiment, other policies can be specified for security privileges in routing messages to a target application; for logging message payloads and header fields during a flow execution for subsequent analysis via a monitoring console; and for message throttling used to define a number of instances that an enterprise service bus (ESB) service can spawn to accommodate requests. In addition, policies can be specified for monitoring/tracking an integration flow at a flow level; and for validating messages being processed by the ICS platform against a known schema.

In accordance with an embodiment, an integration developer can drag and drop a component on a development canvas 233 for editing and configuration, for use in designing an integration flow.

As further shown, the runtime environment can include a containerized application provider 265 and a storage service 268, which can be run on compute resources 260. A user interface console 264 can be used to monitor and track performance of the runtime environment. The containerized application provider of the runtime environment can provide a number of containerized compute instances within the compute resources layer. A standalone container engine service can be used to build and launch containerized applications to the cloud. The container service can be used, for example, to build, deploy, and manage cloud-native applications. The container service can specify the compute resources that the containerized applications require, and the container engine can then provision, via the provisioning service, the required compute resources for use within the cloud infrastructure environment (e.g., in the context of a tenancy).

In accordance with an embodiment, one such container service engine that can be used is Kubernetes, an open-source system for automating deployment, scaling, and management of containerized applications across clusters of hosts. Such container services can group the containers that make up an application into logical units for easy management and discovery.

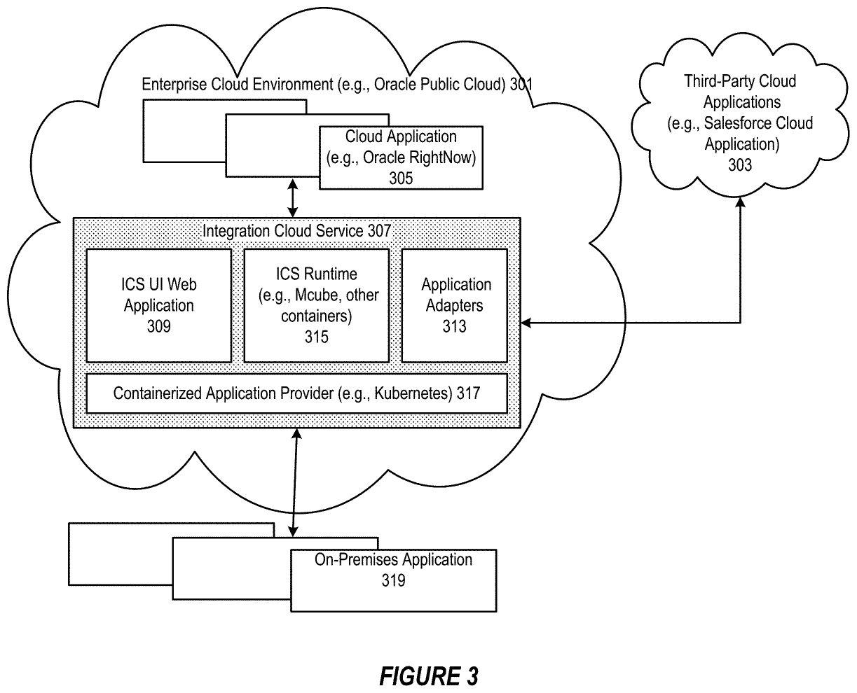

FIG. 3 illustrates an integration cloud service in accordance with an embodiment.

As shown in FIG. 3, an ICS 307 can provide a cloud-based integration service for designing, executing, and managing ICS integration flows. The ICS can include a web application 309 and an ICS runtime 315 executing on a containerized application provider 317, such as Kubernetes described above) in an enterprise cloud environment (for example, Oracle Public Cloud) 301. The web application can provide a design time that exposes a plurality of user interfaces for a user to design, activate, manage, and monitor an ICS integration flow. An activated ICS integration flow can be deployed and executed on the ICS runtime.

In accordance with an embodiment, a plurality of application adapters 313 can be provided to simplify the task of configuring connections to a plurality of applications, by handling the underlying complexities of connecting to those applications. The applications can include enterprise cloud applications of the ICS vendor 305, third-party cloud applications (for example, Salesforce) 303, and on-premises applications 319. The ICS can expose simple object access protocol (SOAP) and representational state transfer (REST) endpoints to these applications for use in communicating with these applications.

In accordance with an embodiment, an ICS integration flow (or ICS integration) can include a source connection, a target connection, and field mappings between the two connections. Each connection can be based on an application adapter, and can include additional information required by the application adapter to communicate with a specific instance of an application.

In accordance with an embodiment, an ICS integration flow and a plurality of other required artifacts (for example, JCA and WSDL files) can be compiled into an ICS project, which can be deployed and executed in the ICS runtime. A plurality of different types of integration flow patterns can be created using the web UI application, including data mapping integration flows, publishing integration flows, and subscribing integration flows. To create a data mapping integration flow, an ICS user can use an application adapter or an application connection to define a source application and a target application in the development interface, and define routing paths and data mappings between the source and target application. In a publishing integration flow, a source application or a service can be configured to publish messages to the ICS through a predefined messaging service. In a subscribing integration flow, a target application or service can be configured to subscribe to messages from the ICS through the messaging service.

### Dynamically Partitioned Multi-Tenant Namespaces

In accordance with an embodiment, all or various portions of cloud services, such as the above described integration cloud service, can be run within a cluster, such as Kubernetes.

In accordance with an embodiment, for example, Oracle Cloud Infrastructure Container Engine for Kubernetes is a fully-managed, scalable, and highly available service that can be used to deploy containerized applications to the cloud. Users may use, for example, Container Engine for Kubernetes (sometimes referred to herein as “OKE”) when a development team wants to reliably build, deploy, and manage cloud-native applications. Users may specify the compute resources that their applications require, and Container Engine for Kubernetes provisions the resources on Oracle Cloud Infrastructure in an existing OCI tenancy.

In accordance with an embodiment, OKE utilizes Kubernetes, an open-source system for automating deployment, scaling, and management of containerized applications across clusters of hosts. Kubernetes groups the containers that make up an application into logical units (which can be referred to herein as “pods”) for easy management and discovery.

In accordance with an embodiment, OKE can be integrated with Oracle Cloud Infrastructure Identity and Access Management (IAM), which provides easy authentication with native Oracle Cloud Infrastructure identity functionality.

In accordance with an embodiment, the following definitions can be used with reference to Kubernetes:

In accordance with an embodiment, the term “cluster” or “clusters” can refer to a set, or sets, of machines individually referred to as nodes used to run containerized applications managed by Kubernetes.

In accordance with an embodiment, the term “node” or “nodes” can refer to either a virtual or physical machine. A cluster consists of a master node and a number of worker nodes.

In accordance with an embodiment, the term “cloud container” can refer to an image that contains software and its dependencies.

In accordance with an embodiment, the term “pod” can refer to a single container or a set of containers running on a Kubernetes cluster.

In accordance with an embodiment, the term “deployment” can refer to an object that manages replicated applications represented by pods. Pods are deployed onto the nodes of a cluster.

In accordance with an embodiment, the term “service instance” can refer to a collection of resources capable of running a resource or a program in the context of a tenant. A service instance can be deployed in the context of a tenant. A tenant can refer to a user, such as an individual, organization (company), or sub-parts of an organization (departments within a company). As an example, a service instance can refer to an instance of an ICS Runtime Environment 263, as described above.

In accordance with an embodiment, the term “partition” can refer to a group of service instances. A partition can be assigned a group of N runtime pods. It should be noted that the term partition within the context of the instant application is not the same as a Kafka partition.

In accordance with an embodiment, the term “lease” can refer to a partition of only 1 service instance.

In accordance with an embodiment, partitions and leases may be temporarily assigned to service instances over some time period.

In accordance with an embodiment, the systems and methods described herein can provide support for limited isolation in runtime by ensuring that a subset of service instances is accessing a particular runtime container at a time

In accordance with an embodiment, the systems and methods described herein can support density by not permanently dedicating runtime containers to any customer/user/tenant.

In accordance with an embodiment, the systems and methods described herein can provide resource affinity. That is, put another way, the systems and methods support resource affinity in terms of having a same instance of an integration application adapters accessing the same external application. This provides for improved in-memory cache affinity, e.g. for integration definitions. As well, this also limits connection fan-out to RDBMS and adapters.

In accordance with an embodiment, the systems and methods described herein provide ‘firebreaks’ that limit the scope of failures and resource starvation that can potentially be caused by a runaway service instance. That is, in the situation where one service instance is running away with CPU utilization or other compute resources, only those other service instances sharing a same partition can be affected.

In accordance with an embodiment, the systems and methods described herein can support isolation in runtime by ensuring that only one customer (Service Instance) or a subset of them is accessing a particular runtime container at a time. The systems and methods can additionally scale a number of containers assigned to a service instance based on a level of assigned service. In addition, the systems and methods provide for flexibility in service level, such as an on-demand increase in service level for any given service instance.

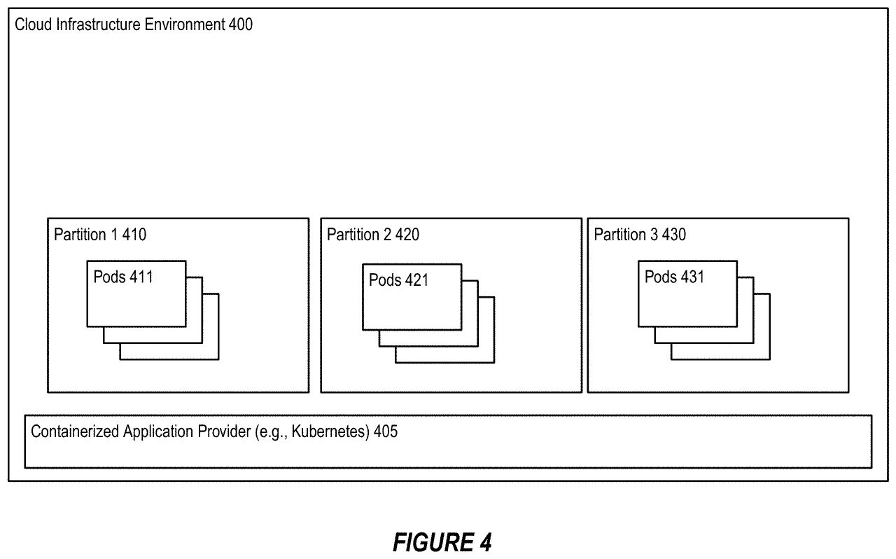

FIG. 4 shows a system for supporting dynamically partition multi-tenant namespaces, in accordance with an embodiment.

In accordance with an embodiment, a cloud infrastructure environment 400, such as described above, can be supported. Within the cloud infrastructure environment 400, an instance of a containerized application provider 405 can be provided. In some embodiments, such a containerized application provided can comprise an instance of Kubernetes. Kubernetes, an open-source system for automating deployment, scaling, and management of containerized applications across clusters of hosts. Kubernetes groups the containers that make up an application into logical units for easy management and discovery.

In accordance with an embodiment, collections of pods 411, 421, and 431 can be logically grouped in to partitions, such as partition 1 410, partition 2 420, and partition 3 430.

In accordance with an embodiment, the collections of pods can provide complete runtimes for complete, or partial versions of software or other programs. For example, each collection of pods can provide an instance of an integration runtime environment 263, as described above. Each instance of the software or other program can be made available to users authorized to access and use the compute resources within each respective partition.

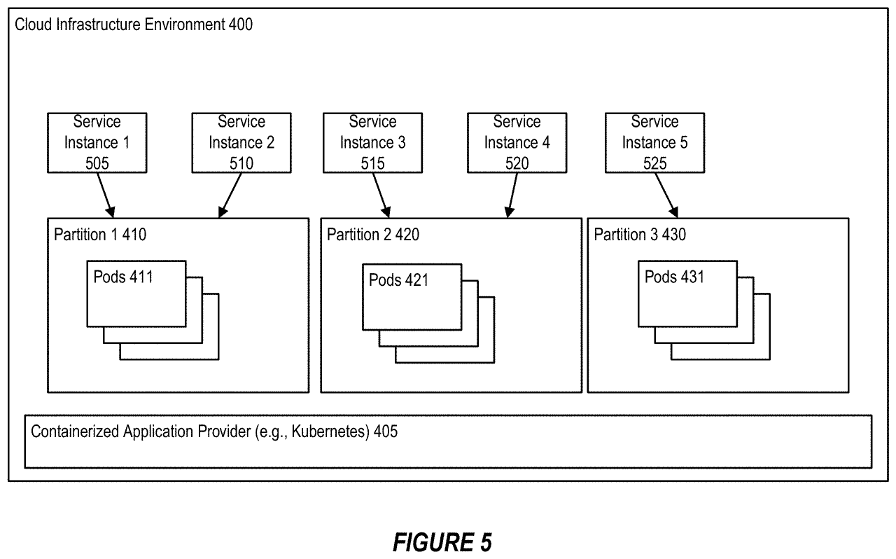

FIG. 5 shows a system for supporting dynamically partition multi-tenant namespaces, in accordance with an embodiment.

In accordance with an embodiment, a cloud infrastructure environment 400, such as described above, can be supported. Within the cloud infrastructure environment 400, an instance of a containerized application provider 405 can be provided. In some embodiments, such a containerized application provided can comprise an instance of Kubernetes. Kubernetes, an open-source system for automating deployment, scaling, and management of containerized applications across clusters of hosts. Kubernetes groups the containers that make up an application into logical units for easy management and discovery.

In accordance with an embodiment, collections of pods 411, 421, and 431 can be logically grouped in to partitions, such as partition 1 410, partition 2 420, and partition 3 430.

In accordance with an embodiment, the collections of pods can provide complete runtimes for complete, or partial versions of software or other programs. For example, each collection of pods can provide an instance of an integration runtime environment 263, as described above. Each instance of the software or other program can be made available to users authorized to access and use the compute resources within each respective partition.

In accordance with an embodiment, as show, each service instance, service instance 1 505, service instance 2 510, service instance 3 515, service instance 4 520, and service instance 5 525 can be associated with a partition of the plurality of partitions.

In accordance with an embodiment, the respective pods can then be utilized only by those service instances mapped to the respective partitions. That is, put another way, service instances 1 and 2 can utilize the resources and instances of applications provided by pods 411, but cannot access or utilize the resources and instances of applications (e.g., Integration Cloud Service) provided by the pods 421 of partition 2 420.

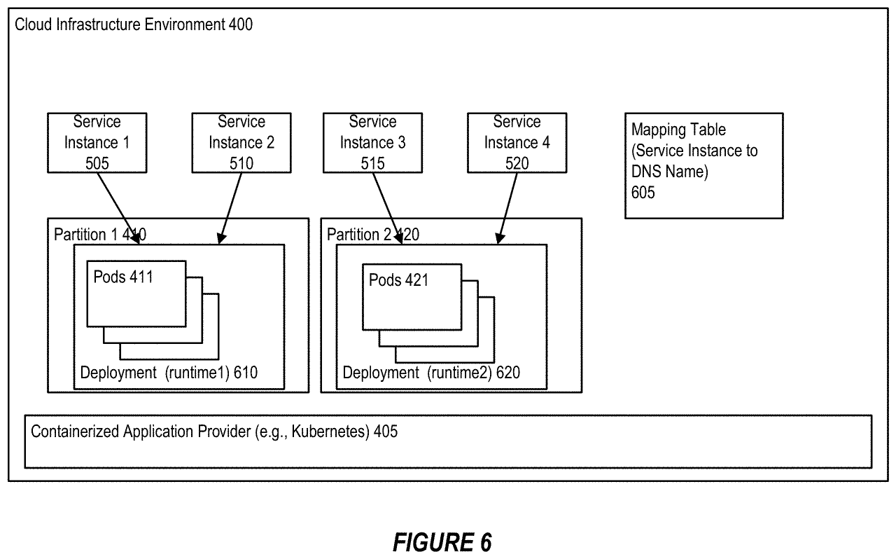

FIG. 6 shows a system for supporting dynamically partition multi-tenant namespaces, in accordance with an embodiment.

In accordance with an embodiment, a cloud infrastructure environment 400, such as described above, can be supported. Within the cloud infrastructure environment 400, an instance of a containerized application provider 405 can be provided. In some embodiments, such a containerized application provided can comprise an instance of Kubernetes. Kubernetes, an open-source system for automating deployment, scaling, and management of containerized applications across clusters of hosts. Kubernetes groups the containers that make up an application into logical units for easy management and discovery.

In accordance with an embodiment, FIG. 6 shows just two partitions, namely partition 1 410 and partition 2 420. This is for the sake of convenience only, as one of skilled in the art would readily understand that a plurality of partitions can be supported within the cloud infrastructure environment.

In accordance with an embodiment, as show, each service instance, service instance 1 505, service instance 2 510, service instance 3 515, service instance 4 520 can be associated with a partition of the plurality of partitions.

In accordance with an embodiment, deployments, such as deployment 610 and deployment 620 can be provided within each partition. A deployment can comprise a group of pods, such as identical pods, that are not uniquely addressable. Instead, each deployment can be fronted by an IP service, such as a ClusterIP service, which provides load balancing between each pod of a deployment. The service provided by each deployment is then addressable by a unique DNS name.

In accordance with an embodiment, each deployment can comprise one or more pods (e.g., for highly-available deployments, each deployment can comprise two or more pods). Each deployment can be appended with, e.g., a sequence number, or each deployment can be placed in separate namespaces (optionally with sequence numbers as well).

In accordance with an embodiment, partitions can assign each deployment within the partition to a service instance, or a group of service instances (e.g., by mapping each service instance to a namespace, or a sequence number, or a namespace and a sequence number).

In accordance with an embodiment, such mappings between service instances and deployments can be contained within a mapping table 605.

In accordance with an embodiment, while only one deployment is shown in the context of each partition in FIG. 6, one of ordinary skill in the art would readily understand and appreciate that one or more deployments can be supported by each partition.

In accordance with an embodiment, the systems and methods provided herein can provide for automatic load balancing between the pods of each deployment. In addition, the systems and methods can facilitate the independent scale out of each deployment, either through manual intervention or using an auto scaling feature of the containerized application provider 405.

In accordance with an embodiment, the partitions, such as partition 1 and partition 2, as well as other partitions not shown in the Figure, can be separated by namespaces. By separating the partitions by namespace, this simplifies routing if runtime microservices are not collocated. Services within the same namespace would route to each other using a non-qualified DNS name.

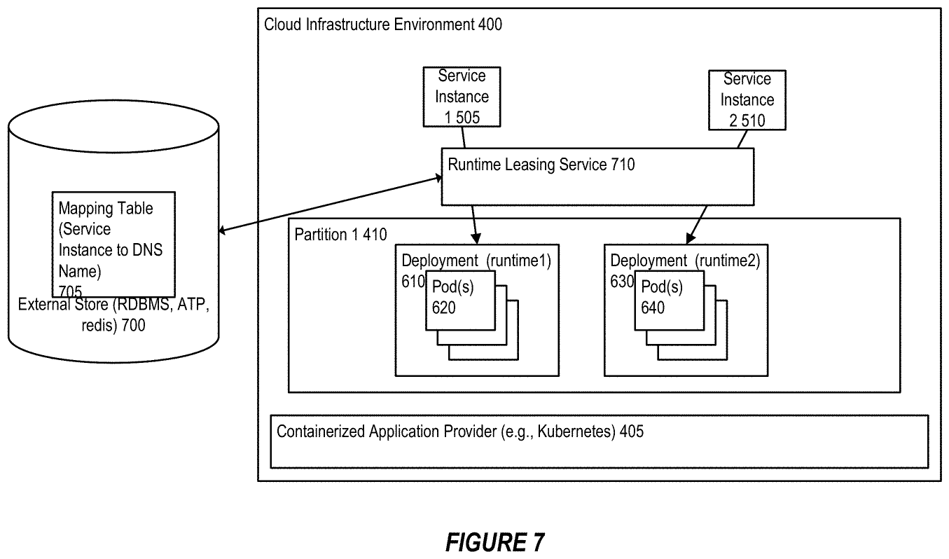

FIG. 7 shows a system for supporting dynamically partition multi-tenant namespaces, in accordance with an embodiment.

In accordance with an embodiment, a cloud infrastructure environment 400, such as described above, can be supported. Within the cloud infrastructure environment 400, an instance of a containerized application provider 405 can be provided. In some embodiments, such a containerized application provided can comprise an instance of Kubernetes. Kubernetes, an open-source system for automating deployment, scaling, and management of containerized applications across clusters of hosts. Kubernetes groups the containers that make up an application into logical units for easy management and discovery.

In accordance with an embodiment, FIG. 7 shows just two partitions, namely partition 1 410 and partition 2 420. This is for the sake of convenience only, as one of skilled in the art would readily understand that a plurality of partitions can be supported within the cloud infrastructure environment.

In accordance with an embodiment, as show, each service instance, service instance 1 505, service instance 2 510, service instance 3 515, service instance 4 520 can be associated with a partition of the plurality of partitions.

In accordance with an embodiment, deployments, such as deployment 610 and deployment 620 can be provided within each partition. A deployment can comprise a group of pods, such as identical pods, that are not uniquely addressable. Instead, each deployment can be fronted by an IP service, such as a ClusterIP service, which provides load balancing between each pod of a deployment. The service provided by each deployment is then addressable by a unique DNS name.

In accordance with an embodiment, each deployment can comprise one or more pods (e.g., for highly-available deployments, each deployment can comprise two or more pods). Each deployment can be appended with, e.g., a sequence number, or each deployment can be placed in separate namespaces (optionally with sequence numbers as well).

In accordance with an embodiment, partitions can assign each deployment within the partition to a service instance, or a group of service instances (e.g., by mapping each service instance to a namespace, or a sequence number, or a namespace and a sequence number).

In accordance with an embodiment, the systems and methods provided herein can route each service instance to a correct runtime container based on the service instance. To do so, the systems and methods can look up a DNS name of the relevant service, based on the service instance. Such a mapping can be stored somewhere persistent, such as an external store 700.

In accordance with an embodiment, such mappings between service instances and deployments can be contained within a mapping table 705 stored in an external store 700, such as an RDBMS or redis store. Note that while the external store is shown as external to the cloud infrastructure, the external store can be contained within the cloud infrastructure as long as the external store is external to the containerized application provider 405.

In accordance with an embodiment, on triggering, a runtime leasing service 710 can access a mapping table 705 stored at the external store 700 to determine which namespace each service instance should be mapped to. Such a lookup could be performed via, e.g., a microservice, or via a direct library lookup from the external store.

In accordance with an embodiment, once looked up, the mappings can be stored in a local cache so as to prevent a lookup from having to be performed each time a runtime is activated.

In accordance with an embodiment, while only one deployment is shown in the context of each partition in FIG. 7, one of ordinary skill in the art would readily understand and appreciate that one or more deployments can be supported by each partition.

In accordance with an embodiment, the systems and methods can collocate adapters and mcube, which would simplify the implementation of partitioning. This could be either collocating adapters+mcube containers within a single pod, or collocating them as libraries in the same virtual machine (e.g., Java Virtual Machine, JVM).

In accordance with an embodiment, a routing library can be used to avoid pre-allocating services for each service instance the caller of each leased/partitioned component would need to use that partition-routing library to lookup the downstream microservice.

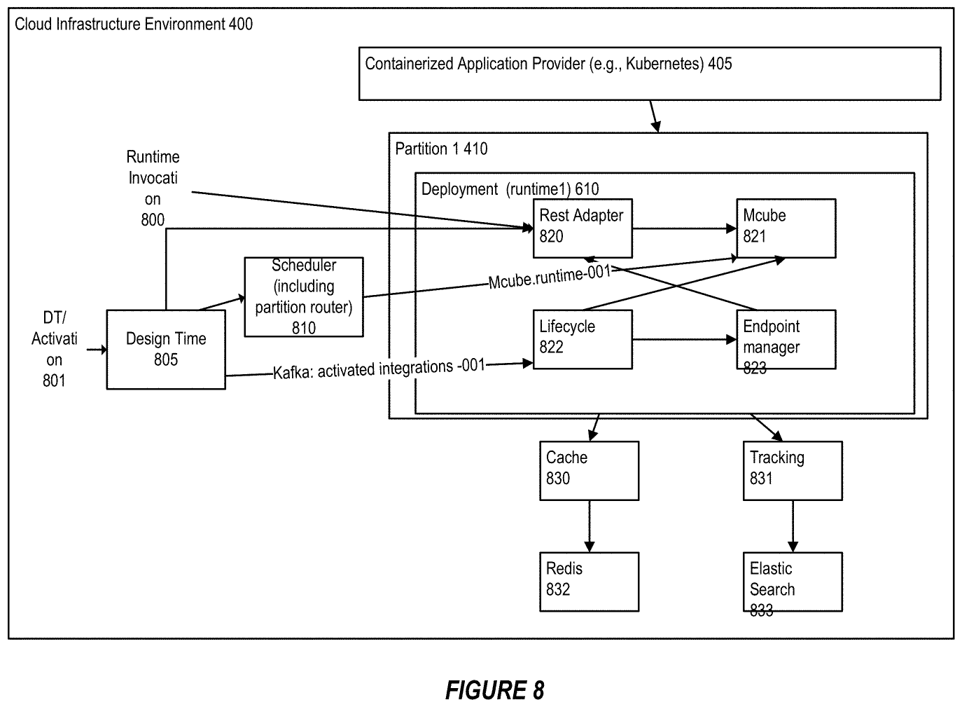

FIG. 8 shows a system for supporting dynamically partitioned multi-tenant namespaces, in accordance with an embodiment.

More specifically, FIG. 8 shows an exemplary runtime embodiment for dynamically partition multi-tenant namespaces in the context of an integration cloud platform.

In accordance with an embodiment, a cloud infrastructure environment 400, such as described above, can be supported. Within the cloud infrastructure environment 400, an instance of a containerized application provider 405 can be provided. In some embodiments, such a containerized application provided can comprise an instance of Kubernetes. Kubernetes, an open-source system for automating deployment, scaling, and management of containerized applications across clusters of hosts. Kubernetes groups the containers that make up an application into logical units for easy management and discovery.

In accordance with an embodiment, FIG. 8 shows partition 1 410, which comprises deployment 610. The figure assumes that a service instance has already been addressed to the runtime 1 within deployment 1 610. Deployment 610 comprises a runtime, which can correspond to a runtime portion of an integration platform, with the other portion of the integration platform, the design time 805, not being within the deployment. As shown, the deployment comprises rest adapters 820, mcube 821, lifecycles 822, and endpoint managers 823. As discussed previously, partition 1 is associated with a unique namespace, and thus a runtime invocation 800 can be addressed to the unique namespace such that the deployment of a runtime portion of the integration platform is run within the partition 1, on the pods as provided by the containerized application provider 405.

In accordance with an embodiment, the design time activation 801 is not addressed to the unique namespace of the partition 1.

In accordance with an embodiment, a schedule 810, which includes a partition router, can address the mcube 821 within the deployment by addressing the unique namespace of the partition 1.

In accordance with an embodiment, the deployment can interact with additional elements of the integration platform likewise outside of the partition, such as cache 830, tracking 831, redis 832, and elastic search 833.

In accordance with an embodiment, mcube and adapters (e.g., application adapters) are partitioned as they are the main tenant-specific runtime flow.

In accordance with an embodiment, activation can be invoked from the design time by, e.g., Kafka. By including activation and endpoint manager in the partition, this simplify routing.

In accordance with an embodiment, the design time can obtain the partition ID (i.e., namespace) from the incoming OracleContext headers, and select the topic to publish to.

In accordance with an embodiment, the return topic from lifecycle back to design time will not be partitioned.

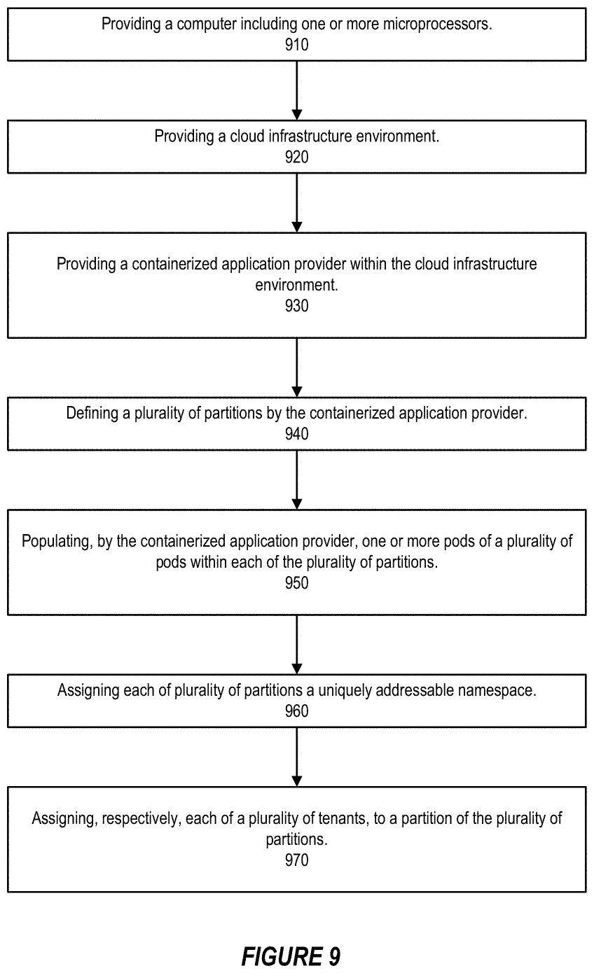

FIG. 9 is a flowchart of a method for supporting dynamically partitioned multi-tenant namespaces, in accordance with an embodiment.

In accordance with an embodiment, at step 910, the method can provide a computer including one or more microprocessors.

In accordance with an embodiment, at step 920, the method can provide a cloud infrastructure environment.

In accordance with an embodiment, at step 930, the method can provide a containerized application provider within the cloud infrastructure environment.

In accordance with an embodiment, at step 940, the method can define a plurality of partitions by the containerized application provider.

In accordance with an embodiment, at step 950, the method can populate, by the containerized application provider, one or more pods of a plurality of pods within each of the plurality of partitions.

In accordance with an embodiment, at step 960, the method can assign each of plurality of partitions a uniquely addressable namespace.

In accordance with an embodiment, at step 970, the method can assign, respectively, each of a plurality of tenants, to a partition of the plurality of partitions.

In accordance with an embodiment, the method can define a deployment within each of the plurality of partitions, each deployment managing at least one pod.

In accordance with an embodiment, the method can provide a replica of a software application at each deployment.

In accordance with an embodiment, the method can run each replication of the software application, respectively, on each of the pods managed by each deployment.

In accordance with an embodiment, the method can provide a plurality of service instances, each of the plurality of service instances being associated with a different tenant of the plurality of tenants, and can further provide a mapping table, the mapping table comprising a mapping of each of the service instances to an assigned partition of the plurality of partitions.

3. In accordance with an embodiment, the method can define store the mapping table at a database external to the containerized application provider.

In accordance with an embodiment, by providing the runtime within deployments within uniquely addressed partitions, the presently disclosed systems and methods can be utilized to prevent “noisy neighbor” problems. That is, by separating tenants (i.e., service instances) to varying partitions, not all tenants will suffer in the event of one tenant over utilizing CPU or other compute resources (only other tenants/service instances assigned to a same partition will be impacted). In addition, in the context of an integration platform, the systems and methods provide for improved resource affinity. As customers and tenants design integration/business flows, these flows often link to external applications and systems. Because of these callouts to external sources/systems, such external systems often have limits on the number of adapters that are allowed to perform such callouts. If, for example, a tenant has 10 replicas of an application adapter, without the partitioning discussed above, all 10 adapters could be talking to the same customer's external application, which may result in locking. By having tenants/service instances isolated to one partition/deployment, this results in only one adapter for each external application.

In some embodiments, features of the present invention are implemented, in whole or in part, in a computer including a processor, a storage medium such as a memory and a network card for communicating with other computers. In some embodiments, features of the invention are implemented in a distributed computing environment in which one or more clusters of computers is connected by a network such as a Local Area Network (LAN), switch fabric network (e.g. InfiniBand), or Wide Area Network (WAN). The distributed computing environment can have all computers at a single location or have clusters of computers at different remote geographic locations connected by a WAN.

In some embodiments, features of the present invention are implemented, in whole or in part, in the cloud as part of, or as a service of, a cloud computing system based on shared, elastic resources delivered to users in a self-service, metered manner using Web technologies. There are five characteristics of the cloud (as defined by the National Institute of Standards and Technology: on-demand self-service; broad network access; resource pooling; rapid elasticity; and measured service. Cloud deployment models include: Public, Private, and Hybrid. Cloud service models include Software as a Service (SaaS), Platform as a Service (PaaS), Database as a Service (DBaaS), and Infrastructure as a Service (IaaS). As used herein, the cloud is the combination of hardware, software, network, and web technologies which delivers shared elastic resources to users in a self-service, metered manner. Unless otherwise specified the cloud, as used herein, encompasses public cloud, private cloud, and hybrid cloud embodiments, and all cloud deployment models including, but not limited to, cloud SaaS, cloud DBaaS, cloud PaaS, and cloud IaaS.

In some embodiments, features of the present invention are implemented using, or with the assistance of hardware, software, firmware, or combinations thereof. In some embodiments, features of the present invention are implemented using a processor configured or programmed to execute one or more functions of the present invention. The processor is in some embodiments a single or multi-chip processor, a digital signal processor (DSP), a system on a chip (SOC), an application specific integrated circuit (ASIC), a field programmable gate array (FPGA) or other programmable logic device, state machine, discrete gate or transistor logic, discrete hardware components, or any combination thereof designed to perform the functions described herein. In some implementations, features of the present invention may be implemented by circuitry that is specific to a given function. In other implementations, the features may implemented in a processor configured to perform particular functions using instructions stored e.g. on a computer readable storage media.

In some embodiments, features of the present invention are incorporated in software and/or firmware for controlling the hardware of a processing and/or networking system, and for enabling a processor and/or network to interact with other systems utilizing the features of the present invention. Such software or firmware may include, but is not limited to, application code, device drivers, operating systems, virtual machines, hypervisors, application programming interfaces, programming languages, and execution environments/containers. Appropriate software coding can readily be prepared by skilled programmers based on the teachings of the present disclosure, as will be apparent to those skilled in the software art.

In some embodiments, the present invention includes a computer program product which is a storage medium or computer-readable medium (media) having instructions stored thereon/in, which instructions can be used to program or otherwise configure a system such as a computer to perform any of the processes or functions of the present invention. The storage medium or computer readable medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. In particular embodiments, the storage medium or computer readable medium is a non-transitory storage medium or non-transitory computer readable medium.

The foregoing description is not intended to be exhaustive or to limit the invention to the precise forms disclosed. Additionally, where embodiments of the present invention have been described using a particular series of transactions and steps, it should be apparent to those skilled in the art that the scope of the present invention is not limited to the described series of transactions and steps. Further, where embodiments of the present invention have been described using a particular combination of hardware and software, it should be recognized that other combinations of hardware and software are also within the scope of the present invention. Further, while the various embodiments describe particular combinations of features of the invention it should be understood that different combinations of the features will be apparent to persons skilled in the relevant art as within the scope of the invention such that features of one embodiment may incorporated into another embodiment. Moreover, it will be apparent to persons skilled in the relevant art that various additions, subtractions, deletions, variations, and other modifications and changes in form, detail, implementation and application can be made therein without departing from the spirit and scope of the invention. It is intended that the broader spirit and scope of the invention be defined by the following claims and their equivalents.

What is claimed is:

1. A system for supporting dynamically partitioned multi-tenant namespaces, comprising:
a computer including one or more microprocessors;
a cloud infrastructure environment; and
a containerized application provider within the cloud infrastructure environment;
wherein a plurality of partitions are defined by the containerized application provider;
wherein one or more pods of a plurality of pods are populated, by the containerized application provider, within each of the plurality of partitions;
wherein each of plurality of partitions are assigned a uniquely addressable namespace; and
wherein each of a plurality of tenants are assigned, respectively, to a partition of the plurality of partitions.

2. The system of claim 1,
wherein a deployment is defined within each of the plurality of partitions, each deployment managing at least one pod.

3. The system of claim 2,
wherein each deployment provides a replica of a software application.

4. The system of claim 3,
wherein each replication of the software application is run, respectively, on each of the pods managed by each deployment.

5. The system of claim 4, further comprising:
a plurality of service instances, each of the plurality of service instances being associated with a different tenant of the plurality of tenants; and
a mapping table, the mapping table comprising a mapping of each of the plurality of tenants to an assigned partition of the plurality of partitions.

6. The system of claim 5,
wherein the mapping table is stored at a database external to the containerized application provider.

7. The system of claim 6,
wherein the containerized application provider comprises a Kubernetes cluster.

8. A method for supporting dynamically partitioned multi-tenant namespaces, comprising:
providing a computer including one or more microprocessors;
providing a cloud infrastructure environment;
providing a containerized application provider within the cloud infrastructure environment;
defining a plurality of partitions by the containerized application provider;
populating, by the containerized application provider, one or more pods of a plurality of pods within each of the plurality of partitions;
assigning each of plurality of partitions a uniquely addressable namespace; and
assigning, respectively, each of a plurality of tenants, to a partition of the plurality of partitions.

9. The method of claim 8, further comprising:
defining a deployment within each of the plurality of partitions, each deployment managing at least one pod.

10. The method of claim 9, further comprising:
providing a replica of a software application at each deployment.

11. The method of claim 10, further comprising:
running each replication of the software application, respectively, on each of the pods managed by each deployment.

12. The method of claim 11, further comprising:
providing a plurality of service instances, each of the plurality of service instances being associated with a different tenant of the plurality of tenants; and
providing a mapping table, the mapping table comprising a mapping of each of the service instances to an assigned partition of the plurality of partitions.

13. The method of claim 12, further comprising:
storing the mapping table at a database external to the containerized application provider.

14. The method of claim 13,
wherein the containerized application provider comprises a Kubernetes cluster.

15. A non-transitory computer readable storage medium, having instructions for supporting dynamically partitioned multi-tenant namespaces, which when read an executed cause a computer to perform steps comprising:
providing a computer including one or more microprocessors;
providing a cloud infrastructure environment;
providing a containerized application provider within the cloud infrastructure environment;
defining a plurality of partitions by the containerized application provider;
populating, by the containerized application provider, one or more pods of a plurality of pods within each of the plurality of partitions;
assigning each of plurality of partitions a uniquely addressable namespace; and
assigning, respectively, each of a plurality of tenants, to a partition of the plurality of partitions.

16. The non-transitory computer readable storage medium of claim 15, the steps further comprising:
defining a deployment within each of the plurality of partitions, each deployment managing at least one pod.

17. The non-transitory computer readable storage medium of claim 16, the steps further comprising:
providing a replica of a software application at each deployment.

18. The non-transitory computer readable storage medium of claim 17, the steps further comprising:
running each replication of the software application, respectively, on each of the pods managed by each deployment.

19. The non-transitory computer readable storage medium of claim 18, the steps further comprising:
providing a plurality of service instances, each of the plurality of service instances being associated with a different tenant of the plurality of tenants; and
providing a mapping table, the mapping table comprising a mapping of each of the service instances to an assigned partition of the plurality of partitions.

20. The non-transitory computer readable storage medium of claim 19, the steps further comprising:
storing the mapping table at a database external to the containerized application provider.
